(19) United States
(12) Patent Application Publication
(10) Pub. No.: US 2008/0180527 A1
(43) Pub. Date: Jul. 31, 2008

(54) Method for Controlling the Field View Size of a Video System, and a Video System, for a Motor Vehicle

(76) Inventors: Bernhard Nixdorf, Stuttgart (DE); Heiner Hild, Ludwigsburg (DE)

Correspondence Address: MICHAEL J. STRIKER, 103 EAST NECK ROAD, HUNTINGTON, NY, 11743, US

(21) Appl. No.: 11/909,421

(22) PCT Filed: Oct. 26, 2006
(86) PCT No.: PCT/EP2006/067816

§ 371 Date: Sep. 21, 2007

(30) Foreign Application Priority Data
Nov. 21, 2005 (DE) 102005055350.8

(51) Int. Cl. H04N 7/18

(52) U.S. Cl. 348/148; 348/E07.085

(57) ABSTRACT

In the case of a method for controlling the field view size of a video system with a video camera in a motor vehicle, and in the case of a video system for a motor vehicle, the invention provides that the field view size be controlled as a function of various functions of the video system. In this case, the field view size can also be controlled as a function of a driving situation, which is derived from at least one input variable.

The present invention relates to a method for controlling the field view size of a video system with a video camera in a motor vehicle, and a video system for a motor vehicle.

### RELATED ART

Publications WO 02/36389 A1 and WO 03/064213 A1 make known night vision infrared devices for motor vehicles, with which the field view size and, optionally, the direction of the field view, is controlled as a function of the vehicle speed and other information, e.g., data representing the surroundings. Data representing the surroundings may be registered, e.g., using special sensors. These data represent the weather, for instance, e.g., whether it is snowing or raining. With the known devices, the direction of the field view may also be adapted to the course of the road using suitable sensors.

In addition to providing night vision support, video systems with other functions have also been made known, e.g., to warn that the vehicle is accidentally leaving the lane (Lane Departure Warning=LDW), to warn about obstacles, and to detect traffic signs. An important parameter to consider when designing video systems of this type is the field view of the video camera, for which another size may be selected, depending on the function. A compromise is typically made between the largest field view possible and sufficiently high resolution, so that objects may be found in the image by the driver or by automatic object detection, and so that they may be recognized.

### ADVANTAGES OF THE INVENTION

The object of the present invention, therefore, is to control the field view size such that a video system may be optimized for various functions.

This object is attained using the inventive method by the fact that the field view is controlled as a function of various functions of the video system. It is preferably provided that there is also a dependence on at least one combination of functions.

According to an advantageous embodiment of the inventive method, the field view size is also controlled as a function of a driving situation, which is derived from at least one input quantity.

With the inventive method, the field view size may be adjusted by controlling the focal distance of the lens of the video camera (“optical zoom”) or by reading everything or a portion from the image sensor of the video camera or a downstream memory (“electronic zoom”). An electronic zoom has the advantage that no mechanically movable parts are required, and, with field views that are smaller than the maximum size required by the image sensor, tilting and swiveling are possible without any additional outlay. As a prerequisite, however, the image sensor must have sufficiently great resolution, so that relevant objects may be detected even when the field view size is small.

All quantities that may bring about any type of reasonable change in the field view size are potential input quantities. They include, e.g., vehicle speed, vehicle yaw rate, steering angle, steering rate, lighting conditions, road conditions, viewing conditions, curve radius, and road type.

To provide quantities of this type, it may be provided in the case of the inventive method that at least one input quantity is obtained from a data system of the motor vehicle, and/or at least one input quantity is supplied by sensors, and/or at least one input quantity is obtained by an image evaluation system from the images that were recorded.

According to a refinement of the inventive method, the input quantities related to a driving stuation and the information about the functions of the video system may be processed by deriving a driving situation from several input quantities using specified evaluation functions, and by selecting a controlled variable for the field view size for each of the various functions of the video system based on the driving system. It may be provided, in particular, that the driving situation is read from a first table as a function of the input quantities, and the controlled variable is read from a second table as a function of the driving situation.

This object is attained using the inventive video system by the fact that the field view size is controllable as a function of various functions of the video system. It is preferably provided that there is also a dependence on at least one combination of functions.

According to an advantageous embodiment of the inventive system, the field view size is also dependent on a driving situation, which is derived from at least one input quantity.

According to a further advantageous embodiment of the inventive video system, a first table is provided for deriving a driving situation based on input quantities supplied, and a second table is provided for defining a controlled variable for the field view size based on the driving situation that was derived for various functions of the video system.

### DRAWING

An exemplary embodiment of the present invention is presented in the drawing based on several figures, and it is described in greater detail in the description below.

FIG. 1 shows a block diagram of an inventive video system,

FIG. 2 shows how the driving situation is derived from steering angle α and speed v, and

FIG. 3 shows a table, based on which a controlled variable for the field view size is generated based on the driving situation and as a function of the particular function that has been activated.

### DETAILED DESCRIPTION OF THE EXEMPLARY EMBODIMENT

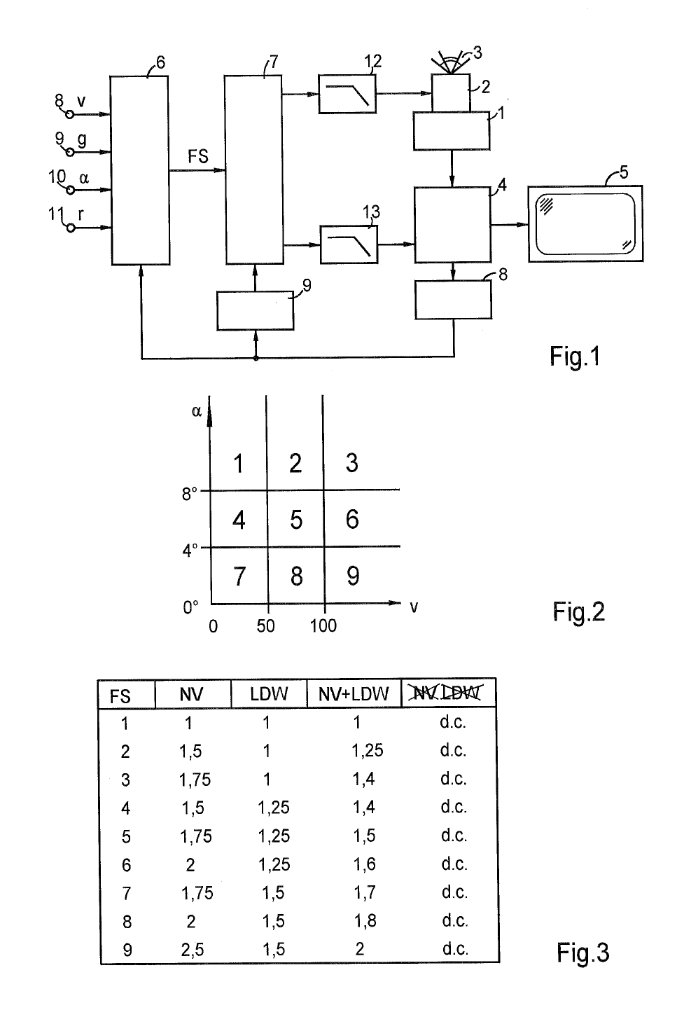

The block diagram in FIG. 1 shows a video camera 1 with a zoom lens 2 and various indicated field views 3. The output signals of video camera 1 are supplied to image processing system 4 in which, e.g., a “digital zoom” is provided, i.e., the generation of a portion of the image that was recorded. An image depiction device 5, e.g., an LCD display, is connected to image processing system 4. This may also be part of a “head up” display. The output data from image processing system 4 may also be supplied to image evaluation 8, which evaluates the image data and transmits suitable data, e.g., LDW (lane departure warning) and traffic sign memory, to a video function 9.

Driving situation FS is estimated or derived in a block 6, and is then forwarded to a further block 7 for determination of the controlled variable. Block 6 may receive many input quantities that describe the driving situation. As an example, four inputs 8 through 11 for supplying speed v from a tachometer, yaw rate g from an inertial sensor, steering angle α from a sensor on the steering wheel, and, e.g., information from a digital card regarding curve radius r.

Further data, e.g., regarding lighting conditions or visibility, are also supplied to block 6 by an image evaluation system 8. If the motor vehicle is equipped with an LDW system, image evaluation system 8 may also determine a curve radius. If data on the same quantities, e.g., vehicle speed, curve radius, and road type, are received from numerous sources, the input data may be improved via data fusion or by performing a plausibility check.

To select a suitable field view, a control signal is supplied to block 7, which indicates which of the functions of the camera system are active, e.g., whether the camera system is being used as a night-view system or an LDW system, or whether both functions are being performed simultaneously.

FIGS. 2 and 3 show how the information regarding the driving situation is processed, using a combination night-view/lane departure warning system as an example. The field view size is to be adjusted as a function of vehicle speed v and steering angle α. The following preferences apply for the two functionalities NV (=night vision) and LDW:

NV:

1. At higher speeds, the range of visibility should be increased using a small field view, i.e., by using a telesetting of the zoom;

2. When driving around curves, the field view should be increased, so the driver may “see into the curve”.

LDW:

1. The range of visibility should always be the same, regardless of the speed;

2. When driving around curves, the field view should be increased, so the driver may “see into the curve”. The field view need only be increased to the extent that a suitable range of visibility is attained that allows the lane to be detected.

FIG. 2 shows a possible imaging function of block 6 (FIG. 1). Vehicle speed v and steering angle α are made discrete by introducing threshold values, thereby resulting in nine possible combinations of value ranges, i.e., nine values of the driving situation. The quantization of input quantities v and a may result in a sudden change of the field view size, in particular when an input quantity of this type continually fluctuates around a quantization threshold. To prevent this, suitable filters, e.g., low-pass filters 12, 13, may be installed between block 7 and zoom lens 2 and image processing system 4. Other types of filters are also feasible, however, e.g., adaptive low passes, the limiting frequency of which is raised when the input quantities change rapidly and to a significant extent, or amplitude filters with hysteretic properties.

FIG. 3 shows the function of block 7. The controlled variable is output as a function of driving situation FS for various functions NV, LDW and NV+LDW. The right-hand column represents the case in which both functions are deactivated. This column therefore contains any type of information, or d.c. (=don't care).

What is claimed is:

1. A method for controlling the field view size of a video system with a video camera in a motor vehicle,
wherein
the field view size is controlled as a function of various functions of the video system.

2. The method as recited in claim 1,
wherein
there is also a dependence on at least one combination of functions.

3. The method as recited in claim 1,
wherein
the field view size is also controlled as a function of a driving situation, which is derived from at least one input quantity.

4. The method as recited in claim 3,
wherein
at least one input quantity is obtained from a data system in the motor vehicle.

5. The method as recited in claim 3,
wherein
at least one input quantity is supplied by sensors.

6. The method as recited in claim 3,
wherein
at least one input quantity is obtained by an image evaluation system from the images that were recorded.

7. The method as recited in claim 3,
wherein
a driving situation is derived from several input quantities using specified evaluation functions, and, based on the driving situation that is derived, a controlled variable for the field view size is selected for each of the various functions of the video system.

8. The method as recited in claim 7,
wherein
the driving situation that is derived is read from a first table as a function of the input quantities, and the controlled variable is read from a second table as a function of the driving situation.

9. A video system for a motor vehicle with a video camera and a device for adjusting the field view size,
wherein
the field view size is controllable as a function of various functions of the video system.

10. The video system as recited in claim 9,
wherein
there is also a dependence on at least one combination of functions.

11. The video system as recited in claim 9,
wherein
the field view size is also dependent on a driving situation, which is derived from at least one input quantity.

12. The video system as recited in claim 11,
wherein
a first table is provided for deriving a driving situation based on input quantities supplied, and a second table is provided for defining a controlled variable for various functions of the video system based on the driving situation that was derived.
